(19) United States
(12) Patent Application Publication
(10) Pub. No.: US 2006/0263189 A1
(43) Pub. Date: Nov. 23, 2006

(54) SYSTEM AND A METHOD FOR MOVING AN IMPLEMENT OF A VEHICLE

(75) Inventor: Bo Vigholm, Stora Sundby (SE)

Correspondence Address: NOVAK DRUCE & QUIGG, LLP, 1300 EYE STREET NW, 400 EAST TOWER, WASHINGTON, DC, 20005, US

(73) Assignee: VOLVO CONSTRUCTION EQUIPMENT HOLDING SWEDEN AB, Eskilstuna (SE)

(21) Appl. No.: 11/164,527

(22) Filed: Nov. 28, 2005

Related U.S. Application Data
(63) Continuation of application No. PCT/SE04/00823, filed on May 28, 2004.

(30) Foreign Application Priority Data
May 28, 2003 (SE) 0301566-6

(51) Int. Cl. B66C 23/00

(52) U.S. Cl. 414/685

(57) ABSTRACT

System and method for moving an implement of a vehicle from a first position to a predetermined, second position. The system includes at least one hydraulically controlled arrangement for moving the implement, an operating valve (20) for regulating the supply of hydraulic oil to the hydraulically controlled arrangement, and a control member (11) hydraulically connected to the operating valve (20) for regulating the operating valve. The control member is configured to be operated by the driver of the vehicle. An arrangement is also provided for reducing the pressure in a pilot line (21) to the operating valve (20), and a control unit (15) is connected to the pressure-reducer (22) in order to control the pressure of the hydraulic oil that is delivered to the operating valve in the pilot line.

### CROSS-REFERENCE TO RELATED APPLICATIONS

The present application is a continuation patent application of International Application No. PCT/SE2004/000823 filed 28 May 2004 which was published in English pursuant to Article 21(2) of the Patent Cooperation Treaty and which claims priority to Swedish Application No. 0301566-6 filed 28 May 2003. Said applications are expressly incorporated herein by reference in their entireties.

### FIELD OF THE INVENTION

The present invention relates to a control system for moving an implement of a vehicle from a first position to a predetermined, second position, the system comprising at least one hydraulically controlled means of moving the implement, an operating valve for regulating the supply of hydraulic oil to the hydraulically controlled means, and a control member hydraulically connected to the operating valve for regulating purposes and the control member is designed for operation by the driver of the vehicle. The invention further relates to a work vehicle comprising such a control system and to a method for moving said implement.

The invention is primarily intended for application of the control system in a work vehicle, such as a wheeled loader. The hydraulically controlled means generally consist of a hydraulic cylinder designed for moving the load arm assembly of the work vehicle, on which the implement is arranged. The control member generally comprises a lever arranged in the cab of the work vehicle for manual operation by the driver.

The invention relates more specifically to a control system which gives the work vehicle a so called “return to dig” or “return to travel” function. The function is as follows; in a loader cycle, for example, when a loader loads gravel onto a load carrier, such as a dumper or truck, the driver fills the shovel (bucket) in the gravel pile or heap and then raises the load arm assembly while at the same time driving to the load carrier in order to empty the shovel. When he returns from the load carrier after emptying the shovel, the load arm assembly must be rapidly lowered to the ground for the next filling of the shovel. The “return to dig” function is employed when lowering the assembly. The load arm assembly is intended to be lowered at maximum speed and braked before coming to rest in the predetermined, second position. The driver can then adjust the shovel to the precise height before it is pushed into the gravel pile again.

### BACKGROUND OF THE INVENTION

US2002/0073833 describes a control system with “return to dig” function. A joystick is used in order to raise the shovel to a raised level with the object of emptying the shovel of a load carrier. An on/off-switch is activated, after which it is possible to initiate the “return to dig” function by pressing a button on the joystick. This causes a solenoid valve arranged on the pilot line that controls the operating valve to be moved from a first, inoperative position, to a second, operative position. As a result, a pilot signal is sent to the operating valve for the hydraulic cylinder, causing the hydraulic cylinder to be moved and thereby moving the shovel to the predetermined excavating position. The rod of the tilt cylinder is provided with a sensor for detecting the position of the cylinder, and hence the vertical position of the shovel. When the shovel reaches a predetermined position, the sensor emits a signal and the movement of the shovel is terminated.

### SUMMARY OF THE INVENTION

A first object of the invention is to provide a control system that fulfills the prerequisites of providing a rapid and reliable lowering movement that is comfortable for the driver when a returning the vehicle implement from a first position to a predetermined second position.

This object is achieved through a system that includes means of reducing the pressure in a pilot line to the operating valve, and a control unit connected to the pressure-reducing means in order to control the pressure of the hydraulic oil that is delivered to the operating valve in the pilot line. The pressure-reducing means preferably (includes, but is not necessarily limited to) an electrically controlled pressure-reducing valve.

According to a preferred embodiment of the invention, the system comprises means of detecting the position of the implement, the means of detection being connected to the control unit. The control unit further comprises software for braking the implement when the implement has reached a predetermined third position. This third position is suitably situated in a vertical position between the first, raised position and the second, lowered position.

A second object of the invention is to provide a method which will bring about a rapid and reliable lowering movement that is comfortable for the driver when returning the vehicle implement from a first position to a predetermined second position.

This object is achieved by steps involving the reception of a signal indicating that said movement is to be initiated, moving of the implement to the second position, detecting that the implement has reached a third position, and braking of the further movement of the implement from the third position to the second position by successively reducing the pressure of a hydraulic oil used to regulate an operating valve, the operating valve being designed to hydraulically control a means of moving the implement.

Other advantageous embodiments of the invention are set forth in the following description.

### BRIEF DESCRIPTION OF THE DRAWINGS

The invention will be described in more detail below with reference to the embodiment shown in the accompanying drawings and in which:

FIG. 1 is a side view of a work vehicle in the form of a wheeled loader;

FIG. 2 is a schematic illustrating first preferred embodiment of a system for controlling the movement of the vehicle implement; and

FIG. 3 is a flow chart indicating the control strategy for movement of the implement.

### DETAILED DESCRIPTION

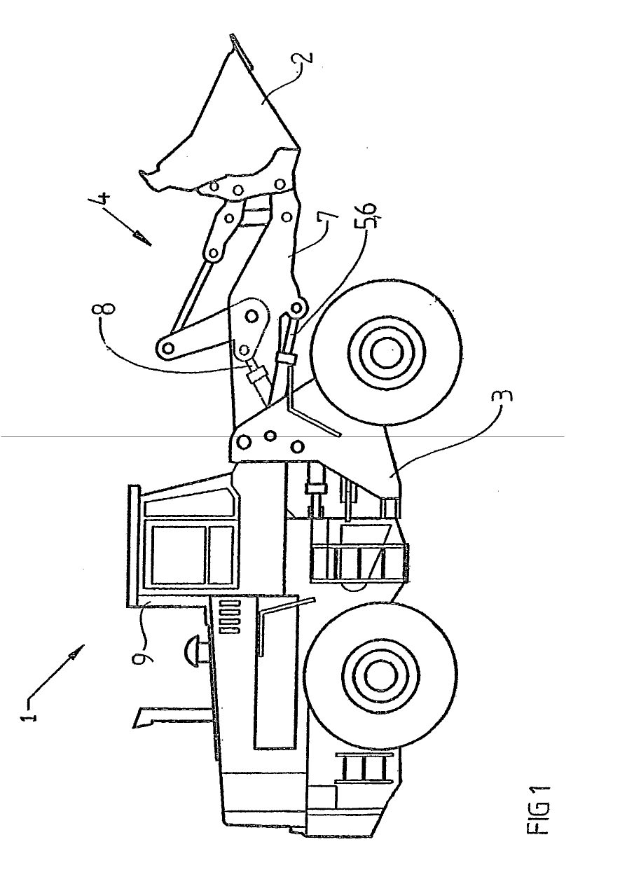

FIG. 1 shows a side view of a wheeled loader 1. The wheeled loader 1 has an implement 2 in the form of a shovel, which can be raised and lowered in relation to the frame 3 of the vehicle, more specifically the front part thereof, by means of a lifting apparatus 4. In this example the lifting apparatus 4 comprises a load arm assembly having two parallel hydraulic cylinders 5,6, each of which is connected at one end to the front part 3 of the vehicle and at its other end to a beam 7 of the load arm assembly. The cab of the wheeled loader 1 is designated by the reference numeral 9.

The shovel 2 can furthermore be tilted in relation to the load arm assembly by means of a third hydraulic cylinder 8, which is connected by one end to the front part 3 of the vehicle and by its other end to the shovel 2 by way of an articulated arm system.

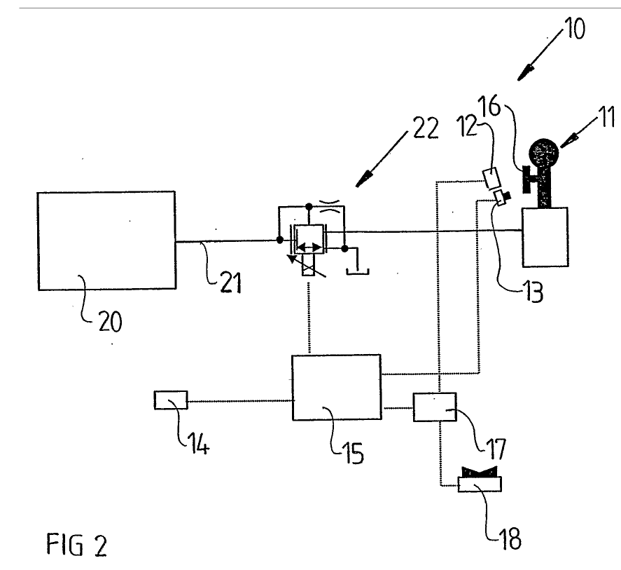

FIG. 2 shows a system 10 for moving the implement 2 of the wheeled loader 1 from a first position to a predetermined second position. The first position corresponds to an arbitrary, raised position, to which the shovel is moved in order to be emptied onto a flat bed or into a skip of a load carrier. The system comprises a control member 11 for manual operation by the driver of the vehicle from the cab 9. The control member here consists of a servo control lever 11. The servo control lever 11 is used for normal moving the implement, that is to say to control the raising, lowering, tilting etc. of the implement. The servo control lever 11 is hydraulically connected to an operating valve 20 via a pilot line 21, and the operating valve 20 is in turn hydraulically connected to the hydraulic cylinders 5,6 for adjusting the latter.

The system further comprises means 22 for reducing the pressure in the pilot line 21, which is coupled to the pilot line 21 between the control member 11 and the operating valve 20. The pressure-reducing means consists of an electrically controlled pressure-reducing valve 22 designed for stepless reduction of the pressure.

The system 10 further comprises means 12,17 for automatically locking the lever 11 in a deployed position, separate from its neutral position. The deployed position corresponds to the maximum lowered position. The locking means comprises an electrically controlled magnet 12. For this purpose the servo control lever 11 is provided with a metal section 16 for interaction with the magnet 12. The system 10 further comprises means 13 for sensing that the control member 11 has been moved to said maximum lowered position. The metal section 16 is also designed (configured) so that with the lever fully out this section exerts an effect on the sensing means 13. The sensing means 13 here consists of a microswitch. The locking means 12,17 further comprises a member 17 coupled to the magnet 12 for deactivating the magnet 12. The deactivating member 17 here consists of a relay designed to interrupt a current that is fed to the magnet. The system 10 further comprises a member 18 which is intended for operation by the driver of the vehicle and is coupled to the relay 17 in order to cause the relay 17 to close the circuit to the magnet 12. The manual operating member 18 suitably consists of a press button or moveable switch.

The system 10 comprises means 14 for detecting the position of the implement 2. The means of detection 14 is more specifically designed for detecting movement of the load arm assembly 4 in relation to the vehicle frame in a known manner. The system further comprises a control unit 15, usually referred to as an electronic control unit (ECU).

The control unit 15 is connected to the pressure-reducing valve 22 in order to control the pressure of the hydraulic oil that is delivered to the operating valve 20. The control unit 15 is furthermore electrically connected to the position detecting means 14, the relay 17 and the control lever detecting means 13.

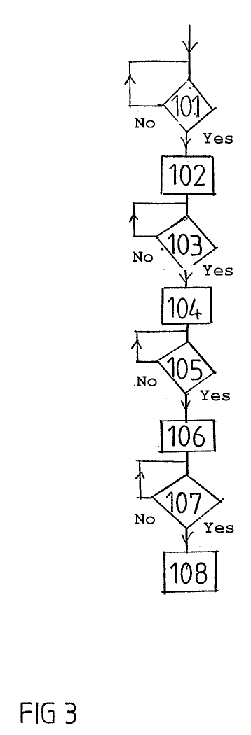

The system 10 described above affords a so-called “return to dig” function, that is to say an automatic lowering movement for returning the implement 2 of the vehicle 1 from the first, raised, arbitrary position to the predetermined lowered, second position. The various steps involved in the function are shown in the flow chart in FIG. 3.

It is first detected 101 that the button 18 has been set to an operative position, and if so, the magnet 12 is supplied 102 with current which means that the magnet is activated.

In order to initiate the function, the servo control lever 11 is brought to the maximum lowered position in which it is automatically locked by the magnet 12. The microswitch 13 indicates 103 that the control lever 11 is in the maximum lowered position. The term maximum lowered position relates to the maximum deployed position of the control lever 11, that is to say the limit position. The operating valve 20 is now set 104 to a position in which the hydraulic cylinders 5,6 are supplied with hydraulic oil. The lift arm assembly 4 is now lowered at maximum speed to a predetermined third position, which is detected 105 by the position detecting means 14. There is consequently an accelerated lowering of the implement 2 to the predetermined, third position. The implement 2 is gently braked 106 from the third position and comes to rest in the second position on a level (at a height) just above ground level. The current that is supplied from the control unit 15 to the pressure-reducing means 22 is more specifically reduced so that the assembly comes gently to a standstill. The position detecting means 14 detects 107 that the implement 2 has reached the second position.

Directly after the pressure-reducing means 22 has braked the implement 2, the current to the magnet 12 is interrupted 108 in about one second so that the control lever 11 is released and goes into neutral. The driver can then adjust the shovel to the precise height before commencing the next working cycles. If no signal is forthcoming from the microswitch 13, that is to say the control lever 11 is not in the maximum lowered position, the pressure-reducing means 22 will ramp down the pressure, i.e., the valve remains open throughout. Regardless of what signal the microswitch 13 emits, the current to the magnet 12 must always be interrupted when the position detecting means 14 emits a signal indicating that the implement is in the second position. This is in order to ensure that the assembly 4 comes to a standstill even when a fault occurs in the microswitch circuit.

The “return to dig” function described is therefore controlled via the servo control lever 11. The servo control lever 11 is, as stated above, also designed to control other operations, such as normal lifting and lowering movement. A further function that can be controlled by the servo control lever 11 is a so-called free-floating function. This function means that the hydraulic control of the lifting apparatus 4 is disconnected in order to allow the implement to follow the ground with a force corresponding to its own weight, and accordingly unaffected by the vehicle hydraulic system. The free-floating function is intended to be locked when the “return to dig” function is in use. This can be achieved in a number of different ways. For example, this can be achieved by suitable designing of the hydraulic system and dimensioning of the components of the system. Alternatively this can be achieved by designing/programming the control unit in order to ensure that the free-floating function cannot be set when the “return to dig” function is in use.

The method of achieving the free-floating function is as follows: Operation of the servo control lever 11 delivers a pressure of 0-18 bar, for example, to the operating valve 20 for normal lowering movement of the hydraulic cylinders 5,6. This is usually termed “powerdown”. At a first set pressure value of 18 bar, for example, the control lever attains a threshold position in the form of a power index usually termed “prefeeling”. When the control lever 11 is shifted through this position and beyond, the pressure increases and at a second set pressure value, for example 25 bar, the pump is disconnected, the hydraulic cylinders 5,6 are connected to a tank, and the free-floating function is achieved.

The free-floating function can be blocked, for example, when ever the implement 2 is situated at a level above the indicating level of the position detecting means 14, for example for the second position. If the implement is below the indicating level of the position detecting means 14, on the other hand, the free-floating function can be set by shifting the control lever to the maximum lowered position. This can be done by the pressure-reducing means 22 ensuring that the pressure that is supplied in the pilot line 21 is maintained at a maximum of 18 bar. That is to say the pressure is reduced from the 25 bar signaled by the servo control lever 11 to 18 bar via the pressure-reducing means 22.

The control unit 15 consists of a computer which comprises software for braking the implement 2 when the implement has reached the predetermined third position. That is to say the signal from the servo control lever 11 is manipulated in order to electrically control the hydraulic pressure-reducing means 22, which in turn controls the operating valve 20 hydraulically.

The single activating button 18 present in the system is therefore the one which feeds current to the hold position magnet 12, which allows the control lever 11 to be locked in the hold position.

The vehicle's control unit 15 contains a memory, which in turn contains a computer program with program code for performing all the steps of the method described above when the program is run. The term computer program product relates to the actual software for performing the method, or hardware on which the software is stored, that is to say a disc or the like.

A number of different characteristics of the ramp can be used for braking the movement of the implement, for example stepped, degressive, linear and progressive.

The invention must not be regarded as being limited to the examples of the embodiments described above; a number of other variants and modifications are feasible without departing from the scope of the patent claims.

The third position for the implement described above need not necessarily be on a height level between the first and second position, but could be on the same level as the second position or a lower level, the implement in the latter two cases being made to return up to the second position after braking.

As another example, a number of sensors may be used for detecting the position of the implement. Instead of designing the position detecting means to detect the movement of the lift arm assembly in relation to the frame, position sensors can alternatively be arranged on one or more of the hydraulic cylinders in order to detect the extent to which they are extended.

Furthermore, the invention can be realized in types of load arm assembly other than that illustrated in FIG. 1, for example in an assembly having only one lifting cylinder.

The invention can also be used in types of work vehicles other than wheeled loaders, such as an excavator loader, also referred to as a “backhoe” loader.

What is claimed is:

1. A system for automatically moving an implement (2) of a vehicle (1) from a first position to a predetermined, second position, the system comprising:
at least one hydraulically controlled means (5,6) for moving the implement;
an operating valve (20) for regulating the supply of hydraulic oil to the hydraulically controlled means (5,6);
a control member (11) in the form of a control lever is connected to the operating valve (20) for regulation thereof, the control member being configured for operation by the driver of the vehicle and being hydraulically connected to the operating valve (20);
pressure reducing means (22) for reducing pressure in a pilot line (21) to the operating valve (20);
a control unit (15) connected to the pressure-reducing means (22) and configured to control the pressure of hydraulic oil delivered to the operating valve in the pilot line in such a way that movement of the implement (2) is braked, and the implement stops in the second position during the automatic movement;
detection means (14) for detecting the position of the implement, the detection means being connected to the control unit (15);
automatic locking means (12,17) for automatically locking the control lever in a deployed position, different from a neutral position thereof, and which deployed position corresponds to lowering of the implement;
said control unit (15) is configured to deactivate the automatic locking means (12,17) when the detection means (14) detects that the second position is reached and so that the control lever (11) resumes the neutral position; and
sensing means (13) for sensing that the control member (11) has been moved to said deployed position for initiation of said automatic movement, wherein the automatic movement that comprises braking of the implement is not performed when the sensing means (13) is not effected by the control member (11).

2. The system as recited in claim 1, wherein the pressure-reducing means (22) is configured for stepless reduction of pressure.

3. The system as recited in claim 1, wherein the pressure-reducing means further comprises an electrically controlled pressure-reducing valve (22).

4. The system as recited in claim 1, wherein the control unit (15) further comprises software for braking the implement (2) when the implement has reached a predetermined third position.

5. The system as recited in claim 1, further comprising:
activation means (18) for activating intended movement and which is designed for operation by the driver of the vehicle.

6. The system as recited in claim 1, wherein the automatic locking means comprises an electrically controlled magnet (12).

7. The system as recited in claim 1, wherein the predetermined, second position locates the implement (2) in a lowered position in which the vehicle can be suitably moved.

8. A method for automatically moving an implement (2) of a vehicle (1) from a first position to a predetermined, second position, said method comprising:
receiving a signal indicating that said automatic movement is to be initiated, said signal being received from a sensing means (13), which is effected by a control member (11), said control member configured for operation by the driver of the vehicle;
moving the implement to the second position;
automatically locking the control member (11) in a deployed position, said deployed position being different from a neutral position of the control member (11) and corresponding to lowering of the implement;
detecting that the implement (2) has reached a third position;
braking further movement of the implement from the third position to the second position by successively reducing the pressure of a hydraulic oil used to regulate an operating valve (22), said operating valve being configured to hydraulically control a moving means (5,6) for the implement;
deactivating said locking when it is detected that the second position is reached so that the control lever (11 ) resumes the neutral position; and
causing normal, non-automatic movement of the implement (2) which is controlled by the position of the driver operated control member (11) without said automatic braking of the movement of the implement being performed when the sensing means (13) is not effected by the control member (11).

9. The method as recited in claim 8, wherein hydraulic oil pressure is reduced by means of a pressure-reducing valve (22).

10. The method as recited in claim 8, wherein an activatable free-floating mode, in which the implement (2) is not powered hydraulically but in the main solely by its own weight, is locked during said movement, and access to the free-floating mode is opened when the implement has reached the second, predetermined position.

11. The method as recited in claim 8, wherein said method steps are embodied in a computer program which is run on a computer.

12. The method as recited in claim 11, wherein said computer program is embodied on a machine-readable means.

13. A vehicle (1) including a system for moving an implement (2) of the vehicle (1) from a first position to a predetermined, second position, the system of the vehicle comprising:
at least one hydraulically controlled means (5,6) for moving the implement;
an operating valve (20) for regulating the supply of hydraulic oil to the hydraulically controlled means (5,6);
a control member (11) in the form of a control lever is connected to the operating valve (20) for regulation thereof, the control member being configured for operation by the driver of the vehicle and being hydraulically connected to the operating valve (20);
pressure reducing means (22) for reducing pressure in a pilot line (21) to the operating valve (20);
a control unit (15) connected to the pressure-reducing means (22) and configured to control the pressure of hydraulic oil delivered to the operating valve in the pilot line in such a way that movement of the implement (2) is braked, and the implement stops in the second position during the automatic movement;
detection means (14) for detecting the position of the implement, the detection means being connected to the control unit (15);
automatic locking means (12,17) for automatically locking the control lever in a deployed position, different from a neutral position thereof, and which deployed position corresponds to lowering of the implement;
said control unit (15) is configured to deactivate the automatic locking means (12,17) when the detection means (14) detects that the second position is reached and so that the control lever (11 ) resumes the neutral position; and
sensing means (13) for sensing that the control member (11) has been moved to said deployed position for initiation of said automatic movement, wherein the automatic movement that comprises braking of the implement is not performed when the sensing means (13) is not effected by the control member (11).

14. A system for moving an implement (2) of a vehicle (1) from a first position to a predetermined, second position, the system comprising:
at least one hydraulically controlled means (5,6) for moving the implement;
an operating valve (20) for regulating the supply of hydraulic oil to the hydraulically controlled arrangement (5,6);
a control member (11) hydraulically connected to the operating valve (20) for regulation thereof, the control member configured for operation by a driver of the vehicle;
pressure-reducing means (22) for reducing the pressure in a pilot line (21) to the operating valve (20); and
a control unit (15) connected to the pressure-reducing means (22) and configured to control the pressure of hydraulic oil delivered to the operating valve in the pilot line.

15. The system as recited in claim 14, wherein the pressure-reducing means (22) is configured for stepless reduction of the pressure.

16. The system as recited in claim 14, wherein the pressure-reducing means further comprises an electrically controlled pressure-reducing valve (22).

17. The system as recited in claim 14, further comprising:
detection means (14) for detecting the position of the implement, said detection means being connected to the control unit (15).

18. The system as recited in claim 17, wherein the control unit (15) comprises software for braking the implement (2) when the implement has reached a predetermined third position.

19. The system as recited in claim 14, further comprising:
the control member (11) being formed as a control lever; and
lock means (12,17) for automatically locking the control lever in a deployed position, separate from as neutral position thereof.

20. The system as recited in claim 19, wherein the lock means comprises an electrically controlled magnet (12).
